(19) United States
(12) Patent Application Publication
(10) Pub. No.: US 2010/0199310 A1
(43) Pub. Date: Aug. 5, 2010

(54) METHODS AND DEVICES FOR RECOMMENDING MEDIA CONTENT

(75) Inventor: Nicholas Brandon Newell, Highlands Ranch, CO (US)

Correspondence Address: SETTER ROCHE LLP, PO BOX 780, ERIE, CO, 80516, US

(73) Assignee: EchoStar Technologies L.L.C., Englewood, CO (US)

(21) Appl. No.: 12/362,720

(22) Filed: Jan. 30, 2009

(51) Int. Cl. H04N 5/445; H04N 7/173

(52) U.S. Cl. 725/46; 725/131

(57) ABSTRACT

A method of recommending media content is presented. In the method, a first media content receiver receives from a first user an indication of recommended media content and an identity of a second user. The indication and an identity of the first user are transmitted to a second media content receiver associated with the second user. The indication, the identity of the first user, and available commands associated with the recommended media content are presented via the second media content receiver to the second user. The second media content receiver receives a selection of one of the available commands from the second user. The recommended media content is processed at the second media content receiver according to the selected command.

### BACKGROUND

Media content receivers, such as audio/video receivers, oftentimes provide the ability to receive and present an immense volume of media content to the user under the control of the user. For example, satellite, cable, and terrestrial (“over-the-air”) television set-top boxes (STBs) allow a user to select at least one channel of broadcast television programming for viewing. Further, some set-top boxes incorporate a digital video recorder (DVR), thus allowing the viewer to record one or more programs for later playback. Additionally, standalone DVR devices are also available for the recording of audio/video programs from any source. Other devices, such as satellite radio receivers, general-purpose computers, personal digital assistants (PDAs), and mobile communication devices, may also provide users viewing and/or recording capability of audio and/or video programming.

Further, some media content receivers provide information regarding the available programming, such as the name, production date, actors, and plot summary of each program. For example, most satellite and cable set-top boxes provide an electronic program guide (EPG) including such information regarding current and future programs to be made available over the next several days.

Given the vast amount of programming typically made available by a media content receiver at any particular time, viewers are often unaware of much of the available content in which they may be interested. Even with an EPG available, reviewing the extensive information included therein is typically onerous. Moreover, even after reviewing such information, the user may not be willing to invest the time to view a program in the absence of a timely recommendation from a friend or other close acquaintance familiar with the program.

### BRIEF DESCRIPTION OF THE DRAWINGS

Many aspects of the present disclosure may be better understood with reference to the following drawings. The components in the drawings are not necessarily depicted to scale, as emphasis is instead placed upon clear illustration of the principles of the disclosure. Moreover, in the drawings, like reference numerals designate corresponding parts throughout the several views. Also, while several embodiments are described in connection with these drawings, the disclosure is not limited to the embodiments disclosed herein. On the contrary, the intent is to cover all alternatives, modifications, and equivalents.

FIG. 1 is a flow diagram of a method according to an embodiment of the invention for recommending media content.

FIG. 2 is a block diagram of a media content communication system according to an embodiment of the invention.

FIG. 3 is a block diagram of a media content receiver of FIG. 2 according to an embodiment of the invention.

FIG. 4 is a block diagram of a communication device of FIG. 2 according to an embodiment of the invention.

FIG. 5 is a block diagram of data storage within the communication device of FIG. 4 according to an embodiment of the invention.

FIGS. 6A and 6B are diagrams depicting communications between the media content receivers and the communication device of FIG. 2 according to an embodiment of the invention.

FIGS. 7A and 7B are graphical representations of communication messages transmitted between the media content receivers and the communication device of FIG. 2 according to an embodiment of the invention.

### DETAILED DESCRIPTION

The enclosed drawings and the following description depict specific embodiments of the invention to teach those skilled in the art how to make and use the best mode of the invention. For the purpose of teaching inventive principles, some conventional aspects have been simplified or omitted. Those skilled in the art will appreciate variations of these embodiments that fall within the scope of the invention. Those skilled in the art will also appreciate that the features described below can be combined in various ways to form multiple embodiments of the invention. As a result, the invention is not limited to the specific embodiments described below, but only by the claims and their equivalents.

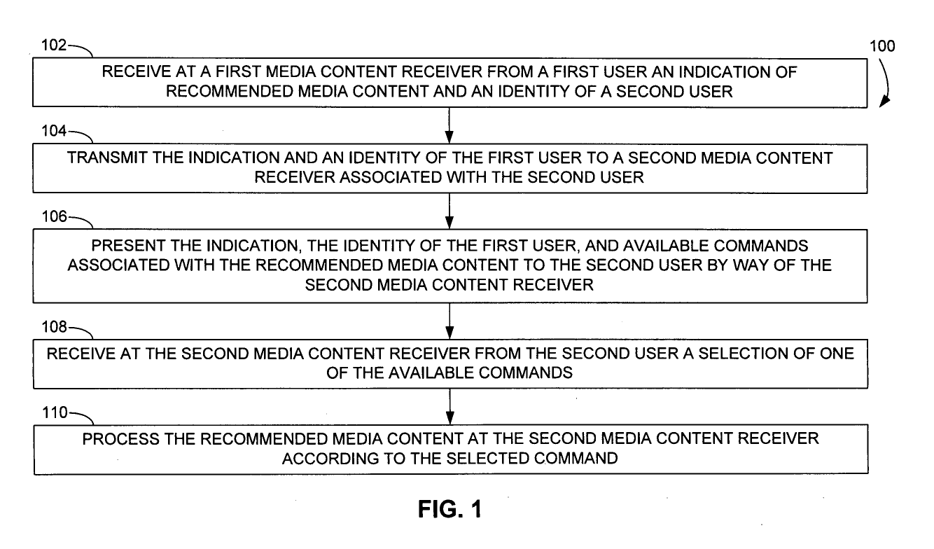

FIG. 1 is a flow diagram describing a method 100 according to an embodiment of the invention for recommending particular media content. In the method 100, a first media content receiver receives from a first user an indication of the recommended media content and an identity of a second user (operation 102). Subsequently, the indication and an identity of the first user are transmitted to a second media content receiver associated with the second user (operation 104). The indication, the identity of the first user, and available commands associated with the recommended media content are presented to the second user by way of the second media content receiver (operation 106). A selection of one of the available commands is received from the second user at the second media content receiver (operation 108). The second media content receiver then processes the recommended media content according to the selected command (operation 110). While FIG. 1 indicates a specific order of execution of the operations 102-110, other possible orders of execution, including concurrent execution of one or more operations, may be undertaken in other implementations. In another embodiment, a computer-readable storage medium may have encoded thereon instructions for a processor or other control logic to direct a device to implement the method 100.

As a result of the method 100, a user of one media content receiver may send a recommendation of a particular program or other portion of media content to a user employing another media content receiver without utilizing separate communication equipment.

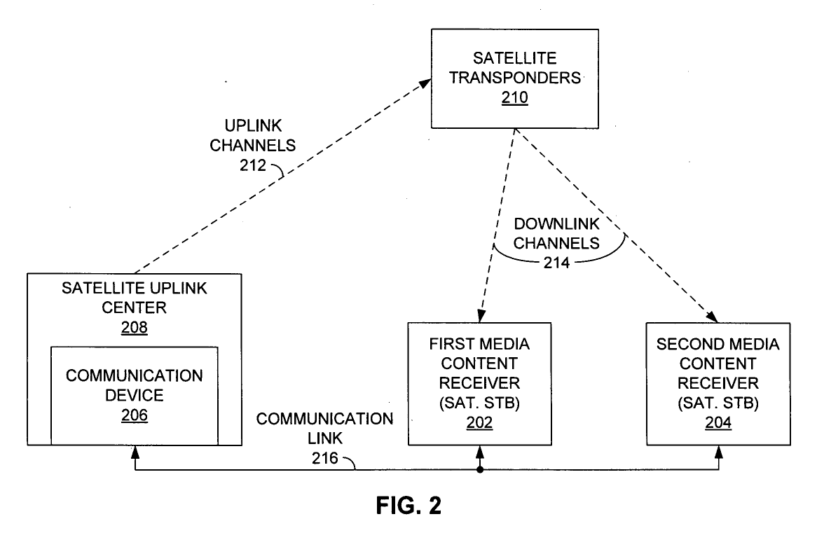

FIG. 2 is a block diagram of a media content communication system 200. The particular example of FIG. 2 exemplifies a satellite television broadcast communication system configured to deliver audio/video content to multiple media content receivers. However, other types of communication systems, such as cable television broadcast communication systems, terrestrial television broadcast communication systems, satellite radio broadcast systems, mobile wireless communication systems, and many types of computer communications systems, such as the Internet, may employ the capability and functionality of the satellite broadcast system explained in greater detail below.

In FIG. 2, the audio/video content being delivered may be any type of media content incorporating audio and/or video elements. Examples of the audio/video content include, but are not limited to, movies, news programs, sporting events, episodic programs, and pay-per-view (PPV) events.

The media content communication system 200 includes a first media content receiver 202 and a second media content receiver 204. In the specific example of FIG. 2, the receivers 202, 204 are satellite television set-top boxes. Also included in the system 200 is a satellite uplink center 208 configured to deliver multiple channels of television and audio programming to the receivers 202, 204 by way of multiple satellite transponders 210, such as what may be incorporated into one or more orbiting satellites. More specifically, the programming is provided by the uplink center 208 over uplink channels 212. In turn, the transponders 210 deliver the programming via multiple downlink channels 214 to the receivers 202, 204. In one example, the audio/video content may be transported over the uplink channels 212 and downlink channels 214 encoded according to one of the Motion Picture Experts Group (MPEG) standards, such as MPEG-2 or MPEG-4, although other video formats may be employed in other implementations. The uplink channels 212 and downlink channels 214 may also carry other information in addition to the programming, such as electronic program guide (EPG) information and security information.

Included at the satellite uplink center 208 is a communication device 206 configured to communicate with the receivers 202, 204 by way of a communication link 216 separate from the uplink channels 212 and downlink channels 214 to provide two-way communication between the uplink center 208 and the media content receivers 202, 204. The communication link 216 thus allows the receivers 202, 204 to provide information to the communication device 206 and the uplink center 208, such as pay-per-view (PPV) event orders and requests for changes to the current service subscription associated with the receiver 202, 204. In these cases, the communication device 206 may be responsible for confirming the current status of the subscribers prior to implementing the orders or requests, and causing the delivery of the PPV service or the change in service. The communication device 206 may be responsible for executing other tasks or functions normally associated with satellite and cable television broadcast systems in addition to those operations described above. In some embodiments, the communication link 216 may be a telephone line or Ethernet link, although other communication paths, either of a wired or wireless variety, may be utilized in other implementations. In one example, communications from the receivers 202, 204 to the communication device 206 are termed “callbacks”.

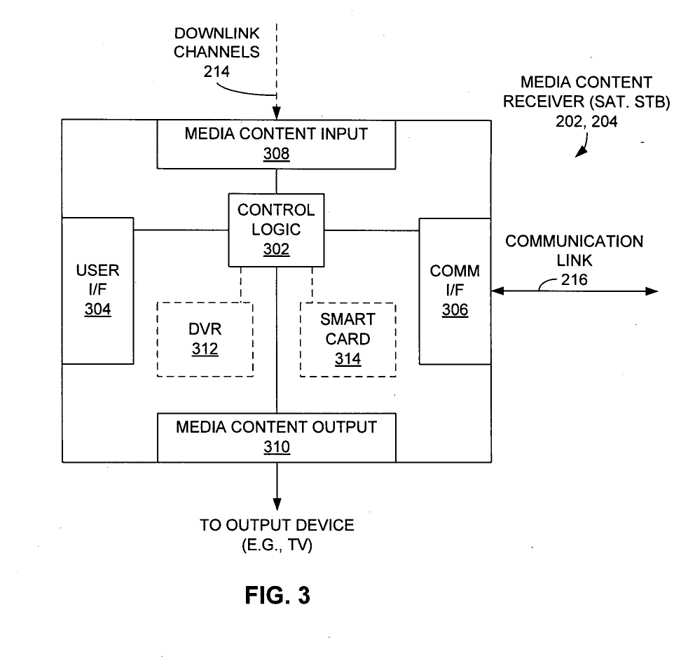

An example of the media content receivers 202, 204 is depicted in the block diagram of FIG. 3. The receiver 202, 204 includes control logic 302, a user interface 304, a communication interface 306, a media content input 308, and a media content output 310. In some embodiments, the receiver 202, 204 may include a digital video recorder (DVR) component 312 for recording selected audio/video content for subsequent viewing. Also, a removable “smart card” 314 may be coupled to the control logic 302 to provide security, subscription, and communication functionality for the receiver 202, 204, as is described more fully below. Also, while the various components of FIG. 3 are shown coupled to each other in a specific configuration, other connection schemes, including bus schemes allowing a unified connection between the control logic 302 and all other components of the receiver 202, 204, may be employed in other implementations.

The media content input 308 is configured to receive media content available via the downlink channels 214 from the satellite transponders 210, as illustrated in FIG. 2. In one embodiment, the media content input 308 may include frequency down-conversion circuitry to shift the frequencies of the downlink channels 214 to frequencies more suitable for processing by the control logic 308. Also, one or more tuner circuits may be included in either the media content input 308 or the control logic 302 to select a specific downlink channel 214 carrying a programming channel of interest.

The media content output 310 is configured to process and transfer programming of at least one selected downlink channel 214 to an output device, such as a television, video monitor, or audio receiver, to present a selected program of interest to the user. The output 310 may transfer the programming or content to the output device in a number of formats, such as modulated video, composite video, component video, and video conforming to the High Definition Multimedia Interface (HDMI). In addition, the media content output 310 or the control logic 302 may include circuitry adapted to de-multiplex and decrypt data associated with the selected programming channel for subsequent formatting and delivery to the output device.

Also in FIG. 3, the user interface 304 is configured to receive input from, and possibly forward status data to, the user of the receiver 202, 204. The user interface 304 may include circuitry for communicating with a remote control device (not shown in FIG. 3) utilized by the user to control the functionality of the receiver 302, 304. Additionally, the user interface 304 may include circuitry to allow user communication by way of a front panel or other hardware structure incorporated within, or coupled with, the receiver 202, 204.

The receiver 202, 204 also includes a communication interface 306 providing the receiver 202, 204 with a connection to the communication link 216 with the communication device 206 of the satellite uplink center 208. In one implementation, the communication interface 306 is a telephone connection, an Ethernet connection, or other wired connection. In other arrangements, the communication interface 306 is configured to engage in a wireless connection with the communication link 216. In another example, the communication interface 306 may include the media content input 308, such as in the case of a computer platform possessing an interface to the Internet, which may serve as both a general communication link and an input for media content. The use of the communication interface 306 as it pertains to the recommendation process is set forth in greater detail below.

As mentioned above, the receiver 202, 204 may also include a DVR 312, allowing the viewer to time-shift programming received over the downlink channels 214 to a more convenient time of the viewer's choosing. Control over the DVR 312 afforded the viewer, such as immediate or timed recording of the programs, viewing of previously recorded programs, and the like, may be facilitated via the user interface 304 and the control logic 302. The DVR 312 may include a data storage device, such as a magnetic or optical disk drive, solid state storage, or another form of data storage for storing the recorded programs.

Also potentially coupled with the receiver 202, 204 is a smart card 314, as mentioned above. The smart card 314 may include information regarding the identity of one or more viewers or subscribers using the receiver 202, 204, as well as information relating to particular services or channels to which the viewer subscribes. In conjunction with the service information, the smart card 314 may include security keys or codes required to decrypt the subscribed-to programming channels to allow presentation of the programming to the user. The smart card 314 may also serve as a basis of communications over the communication link 216 by playing the role of a unique addressable component for the receiver 202, 204.

The control logic 302 of the receiver 202, 204 is configured to control and communicate with the remaining components of the receiver 202, 204 described above. For example, the control logic 302 may include one or more processors, such as a microprocessor, microcontroller, or digital signal processor (DSP), configured to execute instructions directing the processor to perform the functions and facilitate the communication discussed in greater detail below. The control logic 302 may also include memory or data storage adapted to contain such instructions. In another implementation, the control logic 302 may be hardware-based logic, or may include a combination of hardware, firmware, and/or software elements.

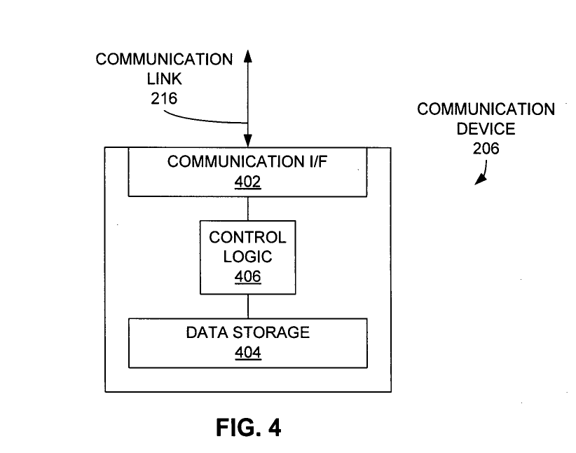

FIG. 4 presents a simplified block diagram of one example of the communication device 206 shown in FIG. 2. In FIG. 4, the communication device 206 includes a communication interface 402, data storage 404, and control logic 406. The particular connections between these components, as shown in FIG. 4, represent the communication pathways in one particular embodiment; other interconnections are possible in other implementations. Other components capable of performing various functions associated with the satellite uplink center 208, as well as an interface to facilitate communication between the communication device 206 and the remainder of the satellite uplink center 208, may reside within the communication device 206, but are not depicted in FIG. 4 nor discussed herein to simplify and focus the discussion of the operation of the communication device 206.

Similar to the communication interface 306 of the receiver 202, 204, the communication interface 402 of the communication device 206 provides a connection to the communication link 216, such as by way of a wired connection, such as via phone or Ethernet connection, or by way of a wireless path. Also, the communication interface 306 may provide enough capacity to communicate with many receivers 202, 204 simultaneously to reduce communication traffic congestion at the communication device 206.

Also, similar to the control logic 302 of the receiver 202, 204, the control logic 406 of the communication device 206 controls the operation of the communication interface 402 and other components of the device 206 in accordance with the functions described more fully below. As before with the control logic 302, the control logic 406 may include one or more processors configured to execute instructions directing the processor to perform the functions and facilitate the communication discussed below. Additionally, the control logic 406 may also include memory or data storage adapted to contain such instructions. In another embodiment, the control logic 406 may include hardware-based logic, or may incorporate a combination of hardware, firmware, and/or software elements.

The control logic 406 also stores data to, and retrieves data from, data storage 404, as depicted in FIG. 4. The data storage 404 may be any kind of digital data storage, including, but not limited to, static random access memory (SRAM), dynamic random access memory (DRAM), flash memory, or other solid state based memory, as well as direct access storage devices, such as one or more magnetic or optical disk drives. Specific to the communications and operations discussed below, the control logic 406 may employ the data storage 404 to store various data regarding established associations, relationships, or logical links between users or subscribers, as well as between users and the receivers 202, 204 they use to view media content.

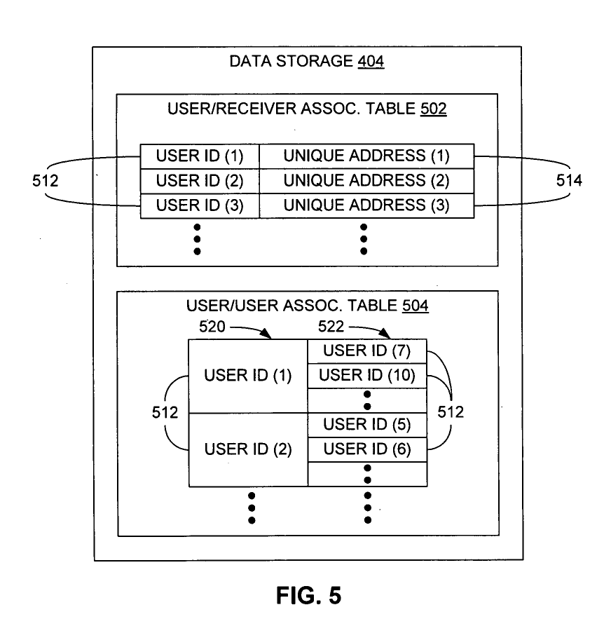

FIG. 5 provides a graphical example of the association data as stored in the data storage 404. Depicted therein are two tables: a user/receiver associations table 502, and a user/user associations table 504. Generally, the user/receiver associations table 502 provides a listing of user identifiers 512, with each user identifier being associated with a particular unique address 514 connected with a receiver 202, 204. In one implementation, each user identifier 512 may be represented by a series of numbers, alphanumeric characters, or other unique data identifying a particular user or subscriber. Each user identifier 512 may be automatically generated by a component of the system 200 (such as the communication device 206) upon the request of the user, may be created manually by the user, or generated in some other fashion.

Each unique address 514 associated with a receiver 202, 204 may be created for a specific receiver 202, 204 at the time the receiver 202, 204 is constructed, similar in fashion to a serial number. In other embodiments, a service provider delivering the media content may generate the unique address when the receiver 202, 204 is delivered to the user, or the receiver 202, 204 is first recognized by the system 200. Other methods for generating each unique address 514 are also possible. In another arrangement, the unique address 514 may not be associated specifically with the receiver 202, 204, but instead with a smart card 314 installed in the receiver 202, 204. A possible advantage of this latter implementation is that a new unique address 514 may not be necessary if the user replaces his older receiver 202, 204 with a newer model. Also, as with the user identifiers 512, each address 514 may be a collection of numbers, alphanumeric characters, or other symbols. In one example, each address 514 may be employed as a communication address in order to transmit messages over the communication link 216 to the associated receiver 202, 204 or smart card 314.

As more than one user may be accessing a receiver 202, 204 to view media content, more than one user identifier 512 may be associated with the same receiver or smart card address 514, with each user identifier 512 corresponding to a separate user. Such implementations allow media content recommendations to be addressed to a particular user, as opposed to the receiver 202, 204 generally, as is discussed more specifically below.

As opposed to associating a user with a specific receiver 202, 204 or smart card 314, the user/user associations table 504 associates each of a number of user identifiers 512 with one or more other user identifiers 512. Generally, the purpose of this table 504 is to identify the other users with which a particular user is permitted to communicate regarding media content recommendations. As shown in FIG. 5, an originating user identifier 520 (such as User ID(1)) may be associated with several receiving user identifiers 522 (including User ID(7) and User ID(10)). Oftentimes, a single user identifier 512 may be represented in separate lists as an originating user identifier 520 and one or more receiving user identifiers 522.

As a result of storing the tables 502, 504, the communication device 206 may serve as a kind of communication access point or gateway for communications involving recommendations issued between users of media content receivers 202, 204, as is discussed more specifically below. While the communication device 206 holds such information, the receivers 202, 204 (or their associated smart cards 314) may also store at least some of the information represented in the tables 502, 504. For example, the receivers 202, 204 may include the receiving user identifiers 522 associated with an originating user identifier 520 that is associated with the receiver 202, 204. Further, multiple such lists may be stored in a single receiver 202, 204, if multiple originating user identifiers 522 are associated with the receiver 202, 204. Further, in a receiver 202, 204, each of the receiving user identifiers 522 stored therein may also be linked with a user-friendly name, such as the first name of the user represented by the receiving user identifier 522. In a related embodiment, the originating user identifiers 520 associated with the receiver 202, 204 may be stored in that receiver 202, 204, with each identifier 520 also possibly being linked to a user-friendly moniker, such as the user's first name.

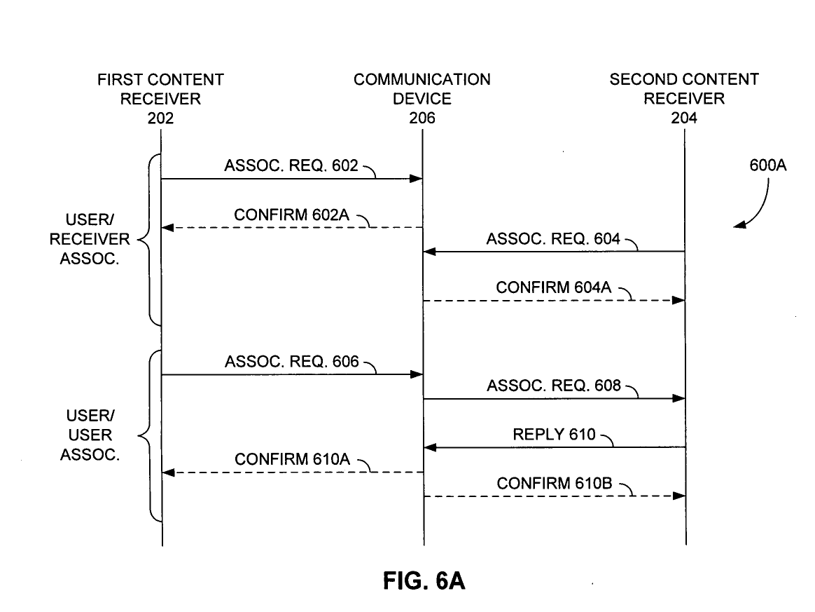

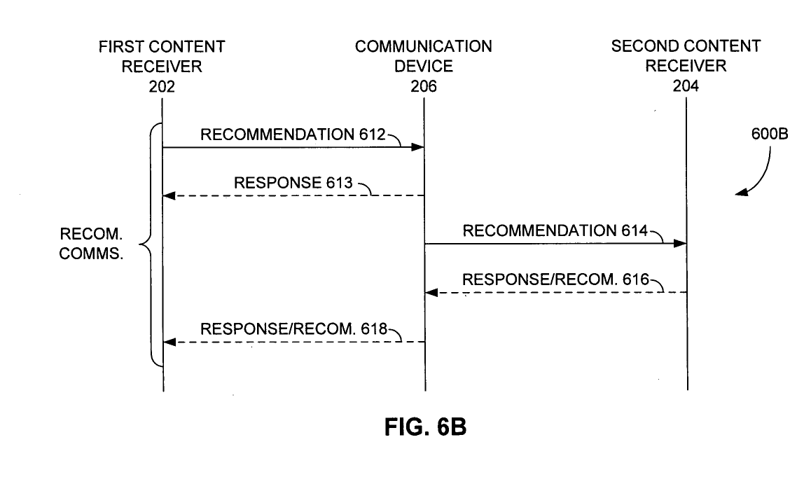

To facilitate the recommendation mechanism, communication among the receivers 202, 204 and the communication device 206 may cause the various elements of the data storage 404 as illustrated in FIG. 5 to be generated. One particular example of such a set of communications 600A is depicted in the communication diagram of FIG. 6A. As shown therein, the first set of communications are associated with the association of users with receivers 202, 204, resulting in at least some of the user/receiver association table 502 being generated in the data storage 404 of the communication device 206. More specifically, a user causes a request 602 to associate the user with the first receiver 202 by way of the user interface 304. In one example, a first user initiates the request by way of a menu system viewable via an output device coupled to the media content output 310 of the first receiver 202. In response to the actions of the first user, the first receiver 202 transmits the request 602 to the communication device 206. In one implementation, the request 602 includes the user ID 512 to be associated with the receiver 202. Optionally, the unique address 514 identified with the receiver 202 may also be transmitted, although such information may be apparent at the communication device 206 in header information or other metadata normally transmitted with any message transferred from the receiver 202 to the device 206.

In response to receiving the user/receiver association request 602, the communication device 206 stores the transmitted user ID 512 and its corresponding unique address 514 in the user/receiver associations table 502 of the data storage 404. In one embodiment, the communication device 206 may also transmit a confirmation 602A to the first receiver 202 to indicate that the requested user/receiver association was successful. If the first receiver 202 does not receive the confirmation 602A within some predetermined period of time after transmitting the request 602, the first receiver 202 may retransmit the request 602.

FIG. 6A also shows similar communications (i.e., a user/receiver association request 604, and a corresponding confirmation 604A) involving the second receiver 404, thus associating a second user with the second receiver 204 by way of a user ID 512 of the user and a unique address 514 of the second receiver 204. Presuming the existence of many receivers similar to the first receiver 202 and the second receiver 204 in communication with the communication device 206 over the communication link 216, many such requests may be made, including multiple requests being made from a single receiver to associate multiple users with that receiver.

In other embodiments, the user/receiver associations may be generated using different methods. For example, such associations may be generated at the time a receiver is conveyed to the user based on information the user has provided to the service provider in order to receive the programming or content.

Once the user/receiver associations of the table 502 have been generated, associations may then be created between users, thus allowing media content recommendations to be transferred therebetween. To this end, FIG. 6A displays one possible set of communications for associating the first user of the first receiver 202 with the second user of the second receiver 204. More specifically, the first user, via the user interface 304 of the first receiver 202, initiates a user/user association request 606 identifying both an originating user (i.e., the first user associated with the first receiver 202) and a receiving user (i.e., the second user associated with the second receiver 204). In one implementation, the user identifications are represented by the user IDs 512 discussed above. In response to the request initiation, the first receiver 202 transmits the request 606 with the two user IDs 512 to the communication device 206.

In response to receiving the user/user association request 606, the communication device 206 may consult the user/receiver associations table 502 to ascertain the receiver associated with the receiving user. In this case, the device 206 would determine that the second receiver 204 is associated with the receiving user, and transmit an association request 608 related to the original association request 606 to the second receiver 204. In one implementation, the association request 606 may be substantially identical to the original association request 606 received from the first receiver 202.

The second receiver 204, upon receiving the user/user association request 608, may cause the request 608 to be presented to the second user via the media content output 310 of the second receiver 204, such as by way of a pop-up window, message indicator, or other mechanism. For example, the media content output 310 by way of a television may inform the second user that the originating user desires the ability to send media content recommendations to the second user. In response, the second user may then employ the user interface 304 to select a ‘yes’ or ‘no’ response as displayed via the television to indicate whether the second user agrees to such an arrangement.

Presuming the second user agrees to the association, the second receiver 204 causes a reply 610 to be transmitted to the communication device 206, indicating an affirmative reply to the requested association. In reaction to the reply 210, the communication device 206 may then store the user ID 512 of the originating (first) user as an originating user ID 520 in the user/user associations table 504, as shown in FIG. 5. Storing the originating user ID 520 in such a fashion would be necessary only if the originating user ID 520 had not already been stored due to a previously user/user association involving the first user. Additionally, the user ID 512 of the second user is stored as an associated user of the first user, thus enabling the first user to send media content recommendations to the second user by way of the communication device 206.

In one embodiment, associating the second user with the first user may also cause the communication device 206 to associate the first user (as the receiving user) with the second user (as the originating user) without the second user explicitly requesting such an association. Thus, the user ID 512 for the second user would be stored as an originating user 520 (if not already stored as the result of a previous user/user association request), and the user ID 512 for the first user would be stored as a receiving user 522 associated with the second user. Further, when the association request 608 from the first user is presented to the second user, the control logic 302 may cause a menu selection to be presented to the second user requesting that the first user (as a receiving user) be associated with the second user (as an originating user). Such selection may then be transmitted within the reply 610 to the communication device 206 for appropriate action.

Once the requested user/user association has been made, the communication device 206 may then issue confirmations 610A, 610B to the first receiver 202 and the second receiver 204 for presentation to the corresponding users by way of the media content output 310. Also, each of the receivers 202, 204 may store the user/user association information for later retrieval to facilitate the subsequent recommendation process.

If, instead, the second user responds negatively to the association request 608 received at the second receiver 204, the reply 610 may indicate that the request was refused. Further, the first user may then receive a confirmation of the negative reply in the confirmation message 610A received at the first receiver 202. In that case, the second receiver 204 may not receive the confirmation 610B described above confirming the negative reply.

After the user/user associations in table 504 described above have been stored, media content recommendations may then be transmitted between the receivers 202, 204 with the aid of the communication device 206. FIG. 6B illustrates a possible set of communications 600B among the receivers 202 involving with the first user sending a recommendation to the second user. First, the first user interacts with the user interface 304 of first receiver 202 to initiate the recommendation. More specifically, the first user may select a media program of interest, such as a sporting event or movie, to recommend. The first user may make such a selection by way of accessing a particular menu item while the program is in progress, by selecting the program by way of an EPG provided by the first receiver 202, by entering the title of the program by way of text entry, or another method. The first user may also select one or more users, including the second user, as the receiving user of the recommendation by way of the appropriate user ID 512. Selection of the user ID 512 may also be made by way of a menu selection from a list of users associated with the first user. Such a list may be stored within the first receiver 202, or may be retrieved from the user/user associations table 504 of the data storage 404 of the communication device 206.

In one embodiment, the first user may also enter a text message to be delivered to the second user as part of the recommendation. This message may, for example, indicate what the first user finds compelling about the recommended media content. Further, the first user may rate the recommended content according to some predetermined rating system employed by other users in the communication system 200. Other information not specifically discussed herein may also be transmitted along with the recommendation.

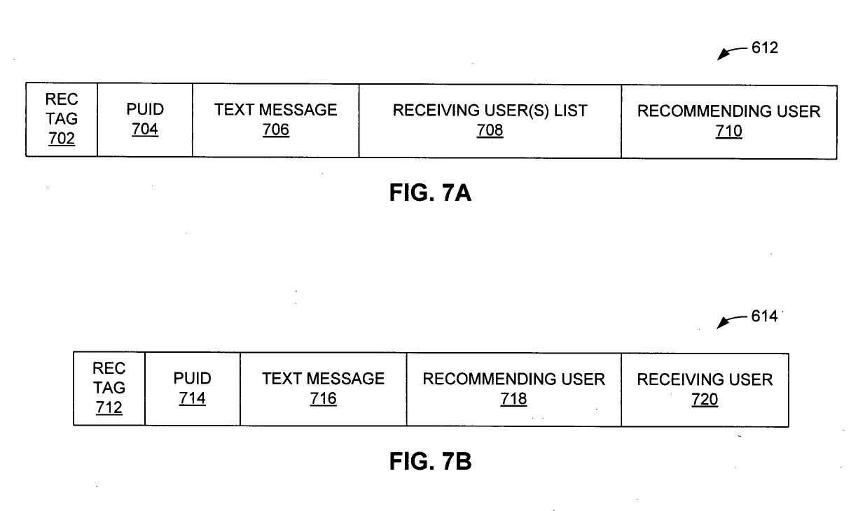

After the first user has initiated the recommendation, the first receiver 202 transmits a recommendation message 612 to the communication device 206 via the communication link 216. FIG. 7A provides a graphical representation of a possible format for the message 612 including the recommendation. More specifically, the message 612 may include a recommendation tag 702 identifying the message as a communication message 612. Also included may be an identification of the recommended content, such as a program unique identifier (PUID) 704, which may indicate a particular episode or showing of a program, or other information identifying the program. Also included in the recommendation message 612 may be a text message 706 provided by the first user, as described above.

Additionally, the recommendation message 612 may include a list of one or more users 708 that are to receive the recommendation, with each user 708 possibly being indicated by way of its user ID 512. In this particular example, the list of users 708 includes the user ID 512 for the second user. Further, the identity of the originating or recommending user 710 (i.e., the first user), such as the user ID 512 of the first user, may be included in the recommendation message 612. Including the user ID 512 of the first user may help prevent confusion as to which of the users of the first receiver 202 initiated the recommendation. Alternatively, information in the header of the message (not shown in FIG. 7A) may include information identifying the first user, such as the user ID 512 of the recommending user, or an address associated with the first receiver 202 (or a smart card 314 located therein) specifically identified with the first user.

As shown in FIG. 6B, after receipt of the recommendation message 612, the communication device 206 may access the user/user association table 504 to confirm that each of the users in the user list 708 is properly associated with the first user. In one example, the communication device 206 may issue a response 613 to the first user via the first receiver 202 indicating whether any of the intended users were not associated with the first user, thus preventing the recommendation from being delivered to those users.

For each of those users of the user list 708 that are associated with the first user, the communication device 206 may issue a recommendation message 614 related to the original recommendation message 612. FIG. 7B provides an example format of the message 614 according to one implementation. Similar to the original recommendation message 612 transmitted by the first receiver 202, the recommendation message 614 transferred to the second receiver 204 may include a recommendation tag 712 identifying the message 614 as a recommendation, the PUID 714 similar or identical to the PUID 704 of the original message 612, and possibly a text message 716 corresponding to the text message 706 of the original message 612. Also included in the message 614 may be an identifier 718, such as the user ID 512, of the recommending user (i.e., the first user). Further, an identifier 720, such as the user ID 512, of the user intended as the recipient of the recommendation (i.e., the second user) may be included. In another arrangement, identifying information for the receiving user may instead be included in the header or other metadata associated with the message 614, as described earlier.

Upon receiving the recommendation message 614 at the second receiver 204, the control logic 302 of the second receiver 204 may cause the recommendation to be presented to the second user by way of the media content output 310, such as by way of a pop-up window, incoming message indicator, visual prompt, or other video- or audio-based mechanism by way of a television coupled with the media content output 310. For example, the second user may be presented with the title of the program, the user ID 512 or other identifying information of the first user, and any text entered by the first user regarding the recommendation.

Additionally, in conjunction with the recommendation, the second receiver 204 may also present to the second user a list of options for responding to the recommendation. In one example, the second receiver 204 may provide a list of options for processing the recommended content within the second receiver 204. These functions may include, but are not limited to, presenting the recommended content to the user immediately, recording the recommended content for subsequent presentation to the second user, setting a viewing reminder for the recommended content, auto-tuning the second receiver 204 to the recommended content when broadcast, or ignoring (or taking no action regarding) the recommended content.

In one implementation, the second receiver 204 may cause the recommended program to be recorded without an explicit selection by the second user to do so. For example, the second user may have previously selected an option to allow the second receiver 204 to record such recommendations from one or more specific users in the event the second user does not react to the received recommendation message 614 prior to the recommended content becoming available. As a result, at least some of the received recommendations may be acted upon positively without timely input from the second user.

Upon the selection of a particular option by the second user by way of the user interface 304 of the second receiver 204, the second receiver 204 processes the recommended program as indicated by the selection. Also, either before or after such processing, the second user may initiate a response 616 to the recommendation 614. More specifically, the second receiver 204 may allow the second user to rate the recommended content according to a predetermined scale, or to include a text message, such as a message indicating the relative merits of the recommended content as viewed by the second user. The second user may also include a recommendation of other media content in the response 616 directed to the first user. In one example, the control logic 302 of the second receiver 204 may provide on-screen menu items to the second user by way of the media content output 310 to aid the second user in initiating the response. Further, in one implementation, the second receiver 204 may present such menu items to the second user upon completion of the presentation of the program to the second user.

After the response message 616 is transmitted to the communication device 206, the device 206 may then forward the response message 616, either modified or in its original form, as a response message 618 to the first receiver 202. Upon presentation to the first user by way of the media content output 310, the first user may then have the option of responding to the response 618 by way of a subsequent recommendation (not shown in FIG. 6B). Further, if the response message 618 includes a media content recommendation from the second user, the first user may employ the user interface 304 to select a particular processing option for the new recommendation, as described in greater detail above. Such recommendations and responses may then continue between the first and second users, and may involve other users of the receivers 202, 204, as well as users associated with other receivers not explicitly depicted in FIG. 2.

At least some embodiments as described herein for recommending media content allow a user of a media content receiver to use the receiver to recommend specific media content, such as an audio/video program, to another user of a separate media content receiver. As a result, the recommending user need not employ other communication means, such as e-mail, to transmit the recommendation. Further, the selection and identification of the content to be recommended may be facilitated by way of an EPG or other means typically provided in a content receiver. Moreover, as the recommendation is received by the separate receiver, the receiver may facilitate processing (e.g., immediate presentation, auto-tuning, or recording) of the recommended content by a simple selection from a list of options provided by the receiver. In addition, user approval of potential recommendation sources may also be provided in some implementations.

While several embodiments of the invention have been discussed herein, other implementations encompassed by the scope of the invention are possible. For example, while various embodiments have been described primarily within the context of satellite and cable audio/video broadcast distribution systems, other systems capable of providing media content, such as those providing communications to PDAs, mobile communication devices, and general purpose computer platforms, may benefit from application of the various concepts described herein. Further, while the implementations discussed above involve the use of a communication device configured to store information regarding associations among users and their media content receivers, other embodiments may not require the use of such a device. In addition, aspects of one embodiment disclosed herein may be combined with those of alternative embodiments to create further implementations of the present invention. Thus, while the present invention has been described in the context of specific embodiments, such descriptions are provided for illustration and not limitation. Accordingly, the proper scope of the present invention is delimited only by the following claims and their equivalents.

What is claimed is:

1. A method of recommending media content, the method comprising:
receiving from a first user at a first media content receiver an indication of recommended media content and an identity of a second user;
transmitting the indication and an identity of the first user to a second media content receiver associated with the second user;
presenting the indication, the identity of the first user, and available commands associated with the recommended media content to the second user via the second media content receiver;
receiving a selection of one of the available commands from the second user at the second media content receiver; and
processing the recommended media content at the second media content receiver according to the selected command.

2. The method of claim 1, wherein:
the available commands comprise at least two of presenting the recommended media content to the second user, recording the recommended media content for subsequent presentation to the second user, setting a viewing reminder for the recommended media content, auto-tuning to the recommended media content, and ignoring the recommended media content.

3. The method of claim 1, further comprising:
receiving from the first user at the first media content receiver a text message associated with the indication;
transmitting the text message to the second media content receiver; and
presenting the text message in conjunction with the indication to the second user via the second media content receiver.

4. The method of claim 1, further comprising:
transmitting the indication and the identity of the second user from the first media content receiver to a communication system; and
confirming an association between the first user and the second user at the communication system;
wherein the transmitting of the indication and the identity of the first user to the second media content receiver is performed by the communication system as a result of the association.

5. The method of claim 4, further comprising:
receiving from the first user at the first media content receiver a request to associate the first user with the second user;
transmitting the request from the first media content receiver to the communication system;
transmitting the request from the communication system to the second media content receiver;
presenting the request to the second user via the second media content receiver;
receiving a reply to the request from the second user at the second media content receiver;
transmitting the reply from the second media content receiver to the communication system; and
associating the first user with the second user at the communication system if the reply comprises an affirmative reply.

6. The method of claim 1, wherein:
the identity of the first user comprises a first user ID;
the identify of the second user comprises a second user ID; and
the method further comprises:
receiving the first user ID from the first user at the first media content receiver;
transmitting the first user ID from the first media content receiver to the communication system;
associating the first user ID with the first media content receiver at the communication system;
receiving the second user ID from the second user at the second media content receiver;
transmitting the second user ID from the second media content receiver to the communication system; and
associating the second user ID with the second media content receiver at the communication system.

7. The method of claim 1, further comprising:
after the presenting of the indication and the identity of the first user to the second user, receiving a text message from the second user at the second media content receiver;
transmitting the text message to the first media content receiver; and
presenting the text message to the first user via the first media content receiver.

8. The method of claim 1, further comprising:
after the presenting of the indication and the identity of the first user to the second user, receiving a second indication of second recommended media content from the second user at the second media content receiver;
transmitting the second indication to the first media content receiver;
presenting the second indication and second available commands associated with the second recommended media content to the first user via the first media content receiver;
receiving a second selection of one of the second available commands from the first user at the first media content receiver; and
processing the second recommended media content at the first media content receiver according to the second selected command.

9. A media content receiver, comprising:
a user interface;
a communication interface;
a media content output configured to present media content to users; and
control logic configured to:
receive an indication of recommended media content and an identity of a first user of another media content receiver via the communication interface;
present the indication, the identity of the first user, and available commands associated with the recommended media content to a second user via the media content output;
receive a selection of one of the available commands from the second user via the user interface; and
process the recommended media content according to the selected command.

10. The media content receiver of claim 9, wherein:
the available commands comprise at least two of presenting the recommended media content via the media content output, recording the recommended media content for subsequent presentation via the media content output, setting a viewing reminder for the recommended media content, auto-tuning to the recommended media content, and ignoring the recommended media content.

11. The media content receiver of claim 9, further comprising:
a media content input configured to receive the media content.

12. The media content receiver of claim 11, wherein:
the communication interface comprises the media content input.

13. The media content receiver of claim 9, wherein:
the user interface comprises a remote control interface.

14. The media content receiver of claim 9, wherein:
the control logic is configured to notify the second user of the reception of the indication by way of a visual prompt via the media content output.

15. The media content receiver of claim 9, wherein:
the control logic is configured to receive the selection of one of the available commands by way of a menu selection via the user interface.

16. The media content receiver of claim 9, wherein:
the control logic is configured to receive an indication of second recommended media content and an identity of the first user from the second user via the user interface, and transmit the indication via the communication interface using the identity of the first user.

17. The media content receiver of claim 16, wherein:
the control logic is configured to receive the indication of second recommended media content by way of at least one of a menu selection, a selection from an electronic program guide, and text entry via the user interface.

18. The media content receiver of claim 9, wherein:
the control logic is configured to receive a request to associate the second user with the first user via the user interface, and transmit the request via the communication interface.

19. The media content receiver of claim 9, wherein:
the control logic is configured to receive a request to associate the first user with the second user via the communication interface, present the request to the second user via the media output interface, receive a reply to the request from the second user via the user interface, and transmit the reply via the communication interface.

20. A communication device, comprising:
a communication interface configured to communicate with media content receivers;
data storage configured to store associations between users of the media content receivers; and
control logic configured to:
receive from a first media content receiver an indication of recommended media content and an identity of a second user associated with a second media content receiver; and
transmit the indication and an identity of a first user associated with the first media content receiver to the second media content receiver if an association between the first user and the second user is stored in the data storage.

21. The communication device of claim 20, wherein:
the data storage is configured to store associations between the users and the media content receivers; and
the control logic is configured to:
receive from the first media content receiver a request to associate the first user with the first media content receiver;
store an association of the first user and the first media content receiver in the data storage;
receive from the second media content receiver a request to associate the second user with the second media content receiver; and
store an association of the second user and the second media content receiver in the data storage.

22. The communication device of claim 21, wherein:
the control logic is configured to receive from the first media content receiver a request to associate the first user with the second user, transmit the request to the second media content receiver, receive a reply to the request from the second media content receiver, and store an association of the first user and the second user in the data storage if the reply comprises an affirmative reply.
